(19) United States
(12) Patent Application Publication
(10) Pub. No.: US 2023/0369677 A1
(43) Pub. Date: Nov. 16, 2023

(54) BATTERY PACK

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Ryotaro SAKAI, Toyohashi-shi (JP); Kousuke MURAISHI, Hamamatsu-shi (JP); Kentaro SUZUKI, Kariya-shi (JP); Yuta NEMOTO, Okazaki-shi (JP); Hiroaki IKEDA, Toyota-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/143,418

(22) Filed: May 4, 2023

(30) Foreign Application Priority Data
May 10, 2022 (JP) 2022-077344

(51) Int. Cl. H01M 10/6566; H01M 50/209; H01M 50/291; H01M 50/538; H01M 10/613

(52) U.S. Cl. CPC H01M 10/6566; H01M 50/209; H01M 50/291; H01M 50/538; H01M 10/613

(57) ABSTRACT

A battery pack includes battery cells and a spacer arranged between two adjacent battery cells. Each battery cell includes an electrode body and a case. The electrode body includes an upper curved portion, a flat portion, and a lower curved portion. The spacer presses one side wall of the case of one of the adjacent battery cells toward an inner side of the case at a part where the side wall opposes a region from the upper curved portion to the lower curved portion. The spacer forms passages for cooling air between the spacer and the side wall. A first cooling efficiency of the cooling air per unit area at a first opposing portion of the side wall that opposes the upper curved portion is less than a second cooling efficiency per unit area at a second opposing portion of the side wall that opposes the flat portion.

### BACKGROUND

### 1. Field

The following description relates to a battery pack including battery cells and spacers arranged between the battery cells.

### 2. Description of Related Art

Battery packs of lithium-ion rechargeable batteries, which are examples of rechargeable batteries, are often used as high-output power sources for driving vehicles or the like. A battery pack includes battery cells and spacers each arranged between adjacent ones of the battery cells. Each battery cell includes a case accommodating an electrode body. An external terminal of the positive electrode of one battery cell and an external terminal of the negative electrode of an adjacent battery cell are connected to each other by a busbar so that the battery cells are connected in series (refer to Japanese Laid-Open Patent Publication No. 2016-91665).

### SUMMARY

In order to increase the life of a battery pack, it is desirable that the life of each battery cell in the battery pack be prolonged. However, charging or discharging of the battery pack greatly raises the temperature at the external terminal of each battery cell. In such a case, heat will be transferred from the external terminals to the electrode body located near the external terminals. This increases the temperature at the portion to where heat is transferred and causes the temperature to vary between different portions of the electrode body. Such temperature variation within the electrode body decreases the life of the battery cell. In particular, battery packs used in hybrid electric vehicles or the like that require high inputs and high outputs are prone to the above problem.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a battery pack includes battery cells and a spacer. Each battery call includes an electrode body, an electrolyte, a case, and an external terminal. The case accommodates the electrode body and the electrolyte. The external terminal is arranged on an upper part of the case. The battery cells are arranged next to one another in a single direction. The spacer is arranged between one of two side walls of the case of one of the battery cells and one of two side walls of the case of an adjacent one of the battery cells. The electrode body is a flattened roll formed by rolling a stack of a positive electrode sheet, a negative electrode sheet, and a separator. The flattened roll includes a flat portion having two opposing surfaces, an upper curved portion having an upper curved surface that connects upper edges of the two surfaces, and a lower curved portion having a lower curved surface that connects lower edges of the two surfaces. The electrode body is accommodated in the case and located toward a lower end of the case. The spacer presses the one of the side walls toward an inner side of the corresponding case at a part where the one of the side walls opposes a region from the upper curved portion to the lower curved portion. The spacer forms passages through which cooling air flows between the spacer and the one of the side walls. A first cooling efficiency of the cooling air per unit area at a first opposing portion of the one of the side walls that opposes the upper curved portion is less than a second cooling efficiency of the cooling air per unit area at a second opposing portion of the one of the side walls that opposes the flat portion.

In the battery pack, a portion in the passages that contacts the first opposing portion may define a first portion, and a portion in the passages that contacts the second opposing portion may define a second portion. A first average velocity of the cooling air in the first portion in a flowing direction may be less than a second average velocity of the cooling air in the second portion in the flowing direction.

In the battery pack, a first cross-sectional flow area of each of the passages located in the first portion may be less than a second cross-sectional flow area of each of the passages located in the second portion.

In the battery pack, the electrolyte may contact the lower curved surface and have a liquid level below the upper curved portion. The first cooling efficiency may be less than a third cooling efficiency of the cooling air per unit area at a third opposing portion of the one of the side walls that opposes the lower curved portion.

In the battery pack, a third cooling efficiency of the cooling air per unit area at a third opposing portion of the one of the side walls that opposes the lower curved portion may be less than the second cooling efficiency.

In the battery pack, a value of a distance from the external terminal to the electrode body relative to a battery capacity of the one of the battery cells may be greater than or equal to 1.57 mm/Ah.

Other features and aspects will be apparent from the following detailed description, the drawings, and the claims.

### BRIEF DESCRIPTION OF THE DRAWINGS

FIG. 1 is a perspective view of a battery pack.

FIG. 2 is a perspective view of a battery cell included in the battery pack.

FIG. 3 is a perspective view of an electrode body in an unrolled state.

FIG. 4 is a side view showing the internal structure of the battery cell and the structure of a spacer.

FIG. 5 is a front view of the spacer.

FIG. 6 is a front view showing the corresponding relationship of the internal structure of the battery cell and the spacer.

FIG. 7 is a front view showing a modified example of the spacer.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

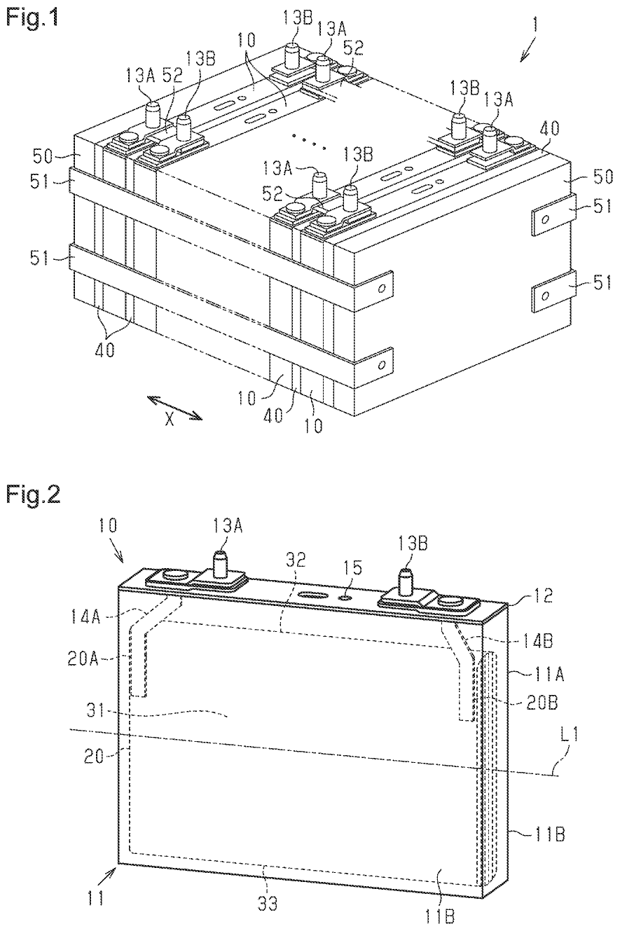

An embodiment of a battery pack will now be described with reference to FIGS. 1 to 7.

Structure of Battery Pack

As shown in FIG. 1, a battery pack 1 includes battery cells 10, spacers 40, two end plates 50, and binding bands 51. The battery cells 10 are arranged next to one another in an arrangement direction X that is a predetermined single direction. The two end plates 50 are arranged at the two ends of the battery pack 1 in the arrangement direction X. Each binding band 51 is attached to the two end plates 50 so as to connect the two end plates 50. The spacers 40 are arranged in the arrangement direction X between adjacent battery cells 10 and between each end plate 50 and the adjacent battery cell 10.

The two end plates 50 sandwich the battery cells 10 and the spacers 40 in the arrangement direction X. Each end of the binding band 51 is fastened to the corresponding end plate 50 by a screw. The binding bands 51 are attached to the end plates 50 so as to apply a predetermined binding pressure in the arrangement direction X. The end plates 50 and the binding bands 51 apply binding pressure to the battery cells 10 and the spacers 40 in the arrangement direction X to hold the battery pack 1 together.

Structure of Battery Cell

As shown in FIG. 2, the battery cell 10 is, for example, a non-aqueous rechargeable battery. In an example, the battery cell 10 is a lithium-ion rechargeable battery. The battery cell 10 includes a case 11. The case 11 includes an accommodation portion 11A and a lid 12. The accommodation portion 11A accommodates an electrode body 20 and a non-aqueous electrolyte. The accommodation portion 11A is box-shaped and has an open upper end.

The lid 12 closes the opening of the accommodation portion 11A. The case 11 forms a sealed battery container by attaching the lid 12 to the accommodation portion 11A. The accommodation portion 11A includes two case side walls 11B opposing each other in the arrangement direction X. One of the case side walls 11B includes a flat surface pressed by a corresponding spacer 40 when the battery pack 1 is assembled. The accommodation portion 11A and the lid 12 are formed from a metal such as aluminum or an aluminum alloy.

An external terminal 13A of the positive electrode and an external terminal 13B of the negative electrode are arranged on the lid 12. The external terminals 13A and 13B are used to charge and discharge the battery cell 10. A positive electrode collector portion 20A, which is the positive electrode end of the electrode body 20, is electrically connected by a positive electrode collector member 14A to the external terminal 13A of the positive electrode. A negative electrode collector portion 20B, which is the negative electrode end of the electrode body 20, is electrically connected by a negative electrode collector member 14B to the external terminal 13B of the negative electrode. The external terminals 13A and 13B do not have to be shaped as shown in FIG. 2 and may have any shape. A busbar 52 (refer to FIG. 1) electrically connects the positive electrode external terminal 13A of a battery cell 10 to the negative electrode external terminal 13B of an adjacent battery cell 10. This connects the adjacent battery cells 10 in series.

An insulative gasket is arranged between the lid 12 and the collector members 14A and 14B. The gasket electrically insulates the lid 12 from the collector members 14A and 14B and seals the gap between the lid 12 and the collector members 14A and 14B. Further, the lid 12 includes an inlet 15 for injecting the non-aqueous electrolyte.

Electrode Body

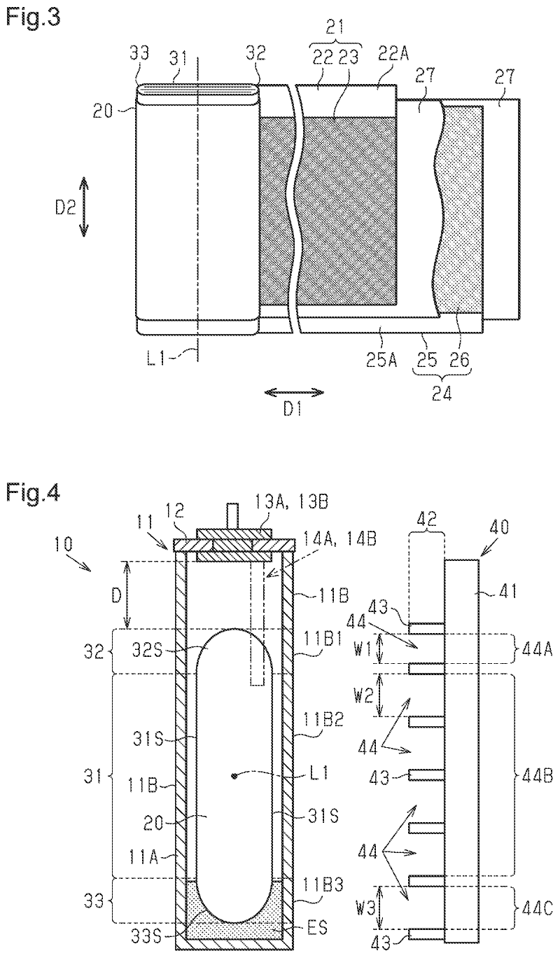

As shown in FIG. 3, the electrode body 20 is a flattened roll formed by rolling a stack of strips of a positive electrode sheet 21, a negative electrode sheet 24, and separators 27. The positive electrode sheet 21, the negative electrode sheet 24, and the separators 27 are stacked so that their long sides are parallel to a longitudinal direction D1. Prior to rolling, the positive electrode sheet 21, the separator 27, the negative electrode sheet 24, and the separator 27 are stacked in this order in a thickness direction. The electrode body 20 is structured by rolling the stack of the positive electrode sheet 21 and the negative electrode sheet 24 with the separators 27 held in between about a rolling axis L1 that extends in a widthwise direction D2 of the strips.

Positive Electrode Sheet

The positive electrode sheet 21 includes a positive electrode collector 22 and a positive electrode mixture layer 23. The positive electrode collector 22 is a strip of an electrode substrate foil. The positive electrode mixture layer 23 is applied to each of the opposing surfaces of the positive electrode collector 22. One end of the positive electrode collector 22 in the widthwise direction D2 includes a positive electrode uncoated portion 22A where the positive electrode mixture layer 23 is not formed and the positive electrode collector 22 is exposed.

The positive electrode collector 22 is a foil of a metal such as aluminum or an alloy having aluminum as a main component. In the roll, the opposing parts in the positive electrode uncoated portion 22A of the positive electrode collector 22 are pressed together to form the positive electrode collector portion 20A.

The positive electrode mixture layer 23 is formed by hardening a positive electrode mixture paste, which is in a liquid form. The positive electrode mixture paste includes a positive electrode active material, a positive electrode solvent, a positive electrode conductive material, and a positive electrode binder. The positive electrode mixture paste is dried and the positive electrode solvent is vaporized to form the positive electrode mixture layer 23. Accordingly, the positive electrode mixture layer 23 includes the positive electrode active material, the positive electrode conductive material, and the positive electrode binder.

The positive electrode active material is a lithium-containing composite metal oxide that allows for the storage and release of lithium ions, which serve as the charge carrier of the battery cell 10. A lithium-containing composite metal oxide is an oxide containing lithium and a metal element other than lithium. The metal element other than lithium is, for example, one selected from a group consisting of nickel, cobalt, manganese, vanadium, magnesium, molybdenum, niobium, titanium, tungsten, aluminum, and iron contained as iron phosphate in the lithium-containing composite metal oxide.

The lithium-containing composite metal oxide is, for example, lithium cobalt oxide (LiCoO₂), lithium nickel oxide (LiNiO₂), or lithium manganese oxide (LiMn₂O₄). The lithium-containing composite metal oxide is, for example, a three-element lithium-containing composite metal oxide that contains nickel, cobalt, and manganese, that is, lithium nickel manganese cobalt oxide (LiNiCoMnO₂). The lithium-containing composite metal oxide is, for example, lithium iron phosphate (LiFePO₄).

The positive electrode solvent is an N-methyl-2-pyrrolidone (NMP) solution, which is an example of an organic solvent. The positive electrode conductive material is, for example, carbon black such as acetylene black or ketjen black, carbon fiber such as carbon nanotubes or carbon nanofiber, or graphite. The positive electrode binder is an example of a resin component included in the positive electrode mixture paste. The positive electrode binder is, for example, polyvinylidene fluoride (PVDF), polyvinyl alcohol (PVA), styrene-butadiene rubber (SBR), or the like.

The positive electrode sheet 21 may include an insulation layer at the boundary between the positive electrode uncoated portion 22A and the positive electrode mixture layer 23. The insulation layer includes an insulative inorganic component and a resin component that functions as a binder. The inorganic material is at least one selected from a group consisting of boehmite powder, titania, and alumina. The resin component is at least one selected from a group consisting of PVDF, PVA, and acrylic.

Negative Electrode Sheet

The negative electrode sheet 24 includes a negative electrode collector 25 and a negative electrode mixture layer 26. The negative electrode collector 25 is a strip of an electrode substrate foil. The negative electrode mixture layer 26 is applied to each of the opposing surfaces of the negative electrode collector 25. One end of the negative electrode collector 25 in the widthwise direction D2 at the side opposite the positive electrode uncoated portion 22A includes a negative electrode uncoated portion 25A where the negative electrode mixture layer 26 is not formed and the negative electrode collector 25 is exposed.

The negative electrode collector 25 is a foil of a metal such as copper or an alloy having copper as a main component. In the roll, the opposing parts in the negative electrode uncoated portion 25A are pressed together to form the negative electrode collector portion 20B.

The negative electrode mixture layer 26 is formed by hardening a negative electrode mixture paste, which is in a liquid form. The negative electrode mixture paste includes a negative electrode active material, a negative electrode solvent, a negative electrode thickener, and a negative electrode binder. The negative electrode mixture paste is dried and the negative electrode solvent is vaporized to form the negative electrode mixture layer 26. Accordingly, the negative electrode mixture layer 26 includes the negative electrode active material, the negative electrode thickener, and the negative electrode binder. The negative electrode mixture layer 26 may further include an additive such as a conductive material.

The negative electrode active material allows for the storage and release of lithium ions. The negative electrode active material is, for example, a carbon material such as graphite, hard carbon, soft carbon, or carbon nanotubes. An example of the negative electrode solvent is water. An example of the negative electrode thickener may be carboxymethyl cellulose (CMC). The negative electrode binder may use the same material as the positive electrode binder. An example of the negative electrode binder is SBR.

Separator

The separators 27 prevent contact between the positive electrode sheet 21 and the negative electrode sheet 24 in addition to holding the non-aqueous electrolyte between the positive electrode sheet 21 and the negative electrode sheet 24. Immersion of the electrode body 20 in the non-aqueous electrolyte results in the non-aqueous electrolyte permeating each separator 27 from the ends toward the center.

Each separator 27 is a nonwoven fabric of polypropylene or the like. The separator 27 may be, for example, a porous polymer film, such as a porous polyethylene film, a porous polyolefin film, or a porous polyvinyl chloride film, an ion conductive polymer electrolyte film, or the like.

As shown in FIG. 4, the electrode body 20 is arranged in the accommodation portion 11A so that the rolling axis L1 extends parallel to the bottom surface of the accommodation portion 11A and so that curved parts of the roll are arranged one above the other. In a state in which the electrode body 20 is accommodated in the case 11, the rolling axis L1 is located at substantially the center of the electrode body 20 in the vertical direction.

The electrode body 20 includes a flat portion 31, an upper curved portion 32, and a lower curved portion 33. The flat portion 31 includes two opposing surfaces 31S. The upper curved portion 32 is located above the flat portion 31. The upper curved portion 32 includes an upper curved surface 32S that connects upper edges of the two surfaces 31S. The upper curved portion 32 has a shape bulging upwardly from the upper end of the flat portion 31. The lower curved portion 33 is located below the flat portion 31. The lower curved portion 33 includes a lower curved surface 33S that connects lower edges of the two surfaces 31S. The lower curved portion 33 has a shape bulging downwardly from the lower end of the flat portion 31. The electrode body 20 is accommodated in the case 11 so that the lower curved portion 33 is located toward the bottom surface of the accommodation portion 11A and the upper curved portion 32 is located toward the lid 12.

One of the case side walls 11B includes a first opposing portion 11B1, a second opposing portion 11B2, and a third opposing portion 11B3. The first opposing portion 11B1 is where the case side wall 11B opposes the upper curved portion 32. The second opposing portion 11B2 is where the case side wall 11B opposes the flat portion 31. The third opposing portion 11B3 is where the case side wall 11B opposes the lower curved portion 33.

The electrode body 20 is accommodated in the case 11 and located toward the lower end of the case 11 so as to be separated from the external terminals 13A and 13B. In the case 11, the external terminals 13A and 13B are where a large amount of heat is generated when charging or discharging the battery cell 10. Accordingly, if the electrode body 20 is accommodated in the case 11 and located toward the lower end of the case 11 so as to be separated from the external terminals 13A and 13B, the heat generated in the external terminals 13A and 13B when charging or discharging the battery cell 10 is less likely to be transferred to the electrode body 20.

The electrode body 20 is connected by the collector members 14A and 14B to the external terminals 13A and 13B in a state in which the electrode body 20 is separated from the external terminals 13A and 13B by a predetermined distance D. Preferably, the distance D from the external terminals 13A and 13B to the electrode body 20 is set based on the battery capacity of the battery cell 10. The value of the distance D (mm) relative to the battery capacity (Ah) of the battery cell 10 is preferably 1.57 mm/Ah or greater, and further preferably 1.96 mm/Ah or greater. When the value of the distance D relative to the battery capacity of the battery cell 10 is greater than or equal to the above, the heat generated in the external terminals 13A and 13B is less likely to be transferred to the electrode body 20. In an example, the distance D is 10 mm or greater. In an example, the battery capacity of the battery cell 10 is 3.5 Ah or greater and 6.5 Ah or less.

When the electrode body 20 is accommodated in the accommodation portion 11A, the lid 12 is arranged on the open end of the accommodation portion 11A and then fixed to the open end through laser welding or the like to seal the opening of the accommodation portion 11A. Then, a non-aqueous electrolyte ES is injected into the case 11 through the inlet 15 of the lid 12. Afterwards, the inlet 15 is sealed through laser welding or the like. The amount of the non-aqueous electrolyte ES in the case 11 is such that it contacts at least the electrode body 20. In an example, the amount of the non-aqueous electrolyte ES in the case 11 is such that the non-aqueous electrolyte ES contacts the lower curved portion 33, with the liquid level of the non-aqueous electrolyte ES being below the upper curved portion 32. In the present embodiment, in order to reduce the amount of the non-aqueous electrolyte ES and reduce the weights of the battery cell 10 and the battery pack 1, the non-aqueous electrolyte ES is injected such that the liquid level is at the upper end of the lower curved portion 33 or slightly below the upper end of the lower curved portion 33.

Non-Aqueous Electrolyte

The non-aqueous electrolyte ES is a composition containing a supporting electrolyte in a non-aqueous solvent. The non-aqueous solvent is one or two or more selected from, for example, a group consisting of propylene carbonate, ethylene carbonate, diethyl carbonate, dimethyl carbonate, and ethyl methyl carbonate. The supporting electrolyte is a lithium compound (lithium salt) of one or two or more selected from, for example, a group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

In the present embodiment, ethylene carbonate is used as the non-aqueous solvent. Lithium bis(oxalate)borate (LiBOB), which is a lithium salt serving as an additive, is added to the non-aqueous electrolyte ES. For example, LiBOB is added to the non-aqueous electrolyte so that the concentration of LiBOB in the non-aqueous electrolyte is 0.001 mol/L or greater and 0.1 mol/L or less.

Spacer

As shown in FIG. 4, each spacer 40 includes a base plate 41 and a projection portion 42. The base plate 41 is formed by, for example, a rectangular plate. The projection portion 42 includes ribs 43 arranged on one surface of the base plate 41 in a comb-tooth pattern. Each rib 43 includes an end surface that is flat to allow for planar contact with the case side wall 11B of the adjacent battery cell 10. The ribs 43 are structured to be equal in height from the surface of the base plate 41. Further, the other surface of the base plate 41 is pressed against the case side wall 11B of the other adjacent battery cell 10.

The projection portion 42 forms passages 44 between adjacent ribs 43 through which cooling air flows to cool the battery cell 10. A portion in the passages 44 that contacts the first opposing portion 11B1 of the case side wall 11B defines a first portion 44A. In the first portion 44A, a single passage 44 is arranged in the vertical direction. A portion in the passages 44 that contacts the second opposing portion 11B2 of the case side wall 11B defines a second portion 44B. In the second portion 44B, multiple passages 44 are arranged in the vertical direction. A portion in the passages 44 that contacts the third opposing portion 11B3 of the case side wall 11B defines a third portion 44C. In the third portion 44C, a single passage 44 is arranged in the vertical direction.

A first passage width W1 of each passage 44 located in the first portion 44A is less than a second passage width W2 of each passage 44 located in the second portion 44B. A first cross-sectional flow area of each passage 44 located in the first portion 44A is less than a second cross-sectional flow area of each passage 44 located in the second portion 44B. The first passage width W1 is less than a third passage width W3 of each passage 44 located in the third portion 44C. The first cross-sectional flow area is less than a third cross-sectional flow area of each passage 44 located in the third portion 44C. The third passage width W3 is greater than or equal to the second passage width W2. The third cross-sectional flow area is greater than or equal to the second cross-sectional flow area.

In an example, the first passage width W1 is preferably 5 mm or greater and 6 mm or less. In an example, the second passage width W2 and the third passage width W3 are preferably 5 mm or greater and 9 mm or less, and further preferably, greater than 6 mm and 9 mm or less.

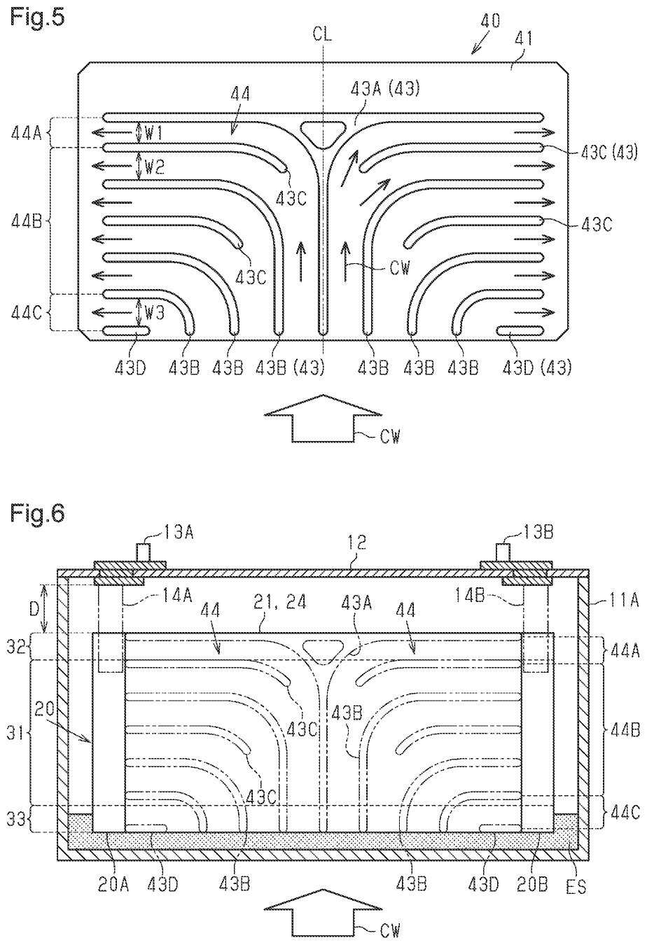

As shown in FIG. 5, the ribs 43 are arranged symmetrically with respect to centerline CL that extends in the vertical direction. The centerline CL is located at the center of the spacer 40 in a direction parallel to the rolling axis L1 of the electrode body 20. The ribs 43 include one first rib 43A, second ribs 43B, third ribs 43C, and fourth ribs 43D.

The first rib 43A includes a first parallel portion that is parallel to the rolling axis L1 and a first vertical portion that is orthogonal to the rolling axis L1. The first parallel portion is the uppermost part of the ribs 43. The first parallel portion presses the upper end of the first opposing portion 11B1 of the case side wall 11B. The first vertical portion extends from the lower end of the base plate 41 toward the first parallel portion in the vertical direction at the center of the first parallel portion. The first vertical portion divides the section between the first parallel portion and the lower end of the base plate 41 into two sections. The second ribs 43B, the third ribs 43C, and the fourth ribs 43D are arranged symmetrically with respect to the first vertical portion between the first parallel portion and the lower end of the base plate 41.

Each second rib 43B extends upwardly from the lower end of the base plate 41 and then toward one side end of the base plate 41. In a first example, the second rib 43B includes a second parallel portion that is parallel to the rolling axis L1, a second vertical portion that is orthogonal to the rolling axis L1, and an arc portion that is arc-shaped and connects the second parallel portion and the second vertical portion. In a second example, the second rib 43B includes the second parallel portion that is parallel to the rolling axis L1 and an arc portion that is arc-shaped and extends from an end of the second parallel portion closer to the centerline CL toward the lower end of the base plate 41. In an example, the second ribs 43B include the second ribs 43B of the first and second examples, and the second parallel portion of each second rib 43B of the second example is located closer to the lower end of the base plate 41 than the second parallel portion of each second rib 43B of the first example. The second parallel portions press the second opposing portion 11B2 of the case side wall 11B. In particular, the second parallel portions of lowermost second ribs 43B press the boundary of the second opposing portion 11B2 and the third opposing portion 11B3 of the case side wall 11B.

Each third rib 43C is arranged between the first rib 43A and an adjacent second rib 43B or between two second ribs 43B. In an example, the third rib 43C includes a third parallel portion that is parallel to the rolling axis L1 and a curved end that is curved downwardly from an end of the third parallel portion closer to the centerline CL. The third rib 43C located between the first rib 43A and the adjacent second ribs 43B divides the passage 44 defined between the first rib 43A and the second rib 43B into two passages. In the same manner, the third rib 43C located between two adjacent second ribs 43B divides the passage 44 defined between the second ribs 43B into two passages. The third parallel portions of the third ribs 43C located between the first rib 43A and the adjacent second ribs 43B press the boundary of the first opposing portion 11B1 and the second opposing portion 11B2 of the case side wall 11B. The third parallel portions of the third ribs 43C located between two adjacent second ribs 43B press the second opposing portion 11B2 of the case side wall 11B.

Each fourth rib 43D is arranged at the lower end of the base plate 41 and is farther from the centerline CL than the second ribs 43B. The fourth rib 43D includes a fourth parallel portion extending parallel to the rolling axis L1. The fourth rib 43D presses the lower end of the third opposing portion 11B3 of the case side wall 11B.

When the battery pack 1 is assembled, cooling air CW is blown toward the spacer 40 from below. The cooling air CW from the lower end of the spacer 40 flows into the passages 44 formed by the ribs 43 and then flows out of the passages 44 near the side ends of the spacer 40.

In a passage 44 defined between the first rib 43A and the second rib 43B closest to the first rib 43A, for example, the cooling air CW from the lower end of the spacer 40 flows into the passage 44 and flows through the third portion 44C to the second portion 44B. The flow rate of the cooling air CW remains constant from when the cooling air CW enters the passage 44 to when the cooling air CW reaches the third rib 43C. Then, the third rib 43C branches the cooling air CW into cooling air CW that flows through the first portion 44A and cooling air CW that continues to flow through the second portion 44B. The flow rate of the cooling air CW flowing through the first portion 44A is less than that before the cooling air CW is branched. Further, since the first cross-sectional flow area is less than the second cross-sectional flow area, the flow rate of the cooling air CW in the first portion 44A is less than that in the second portion 44B. The cooling air CW in the first portion 44A and the cooling air CW in the second portion 44B both flow out of the spacer 40 near the side end.

In a passage 44 defined between two adjacent second ribs 43B, for example, the cooling air CW from the lower end of the spacer 40 flows into the passage 44 and flows through the third portion 44C to the second portion 44B. The flow rate of the cooling air CW remains constant from when the cooling air CW enters the passage 44 to when the cooling air CW reaches the third rib 43C. Then, the third rib 43C branches the cooling air CW into two passages 44 within the second portion 44B. Both branches of the cooling air CW through the two passages 44 flow out of the spacer 40 near the side end. In this case, since the first cross-sectional flow area is less than the second cross-sectional flow area, the flow rate of the cooling air CW flowing through each passage 44 in the second portion 44B is greater than that in the first portion 44A both before and after the cooling air CW is branched. When the third rib 43C is not arranged between the two second ribs 43B, the flow rate of the cooling air CW in the passage 44 remains constant and is greater than the flow rate of the cooling air CW in the first portion 44A.

In a passage 44 defined between one of the fourth ribs 43D and the second rib 43B closest to the fourth rib 43D, for example, the cooling air CW from the lower end of the spacer 40 flows into the passage 44 and flows out of the third portion 44C near the side end of the spacer 40. In this case, the flow rate of the cooling air CW remains constant from when the cooling air CW enters the passage 44 to when the cooling air CW flows out of the passage 44. Since the first cross-sectional flow area is less than the third cross-sectional flow area, the flow rate of the cooling air CW in the first portion 44A is less than the flow rate of the cooling air CW in the third portion 44C.

As described above, in the passages 44, a first flow rate of the cooling air CW in each passage 44 located in the first portion 44A is less than a second flow rate of the cooling air CW in each passage 44 located in the second portion 44B. In the same manner, in the passages 44, the first flow rate is less than a third flow rate of the cooling air CW in each passage 44 located in the third portion 44C. The third flow rate is greater than or equal to the second flow rate. In an example, the first flow rate is 50% or greater and 80% or less of the second flow rate.

The cooling air CW flowing through the first portion 44A cools the first opposing portion 11B1. The cooling air CW flowing through the second portion 44B cools the second opposing portion 11B2. The cooling air CW flowing through the third portion 44C cools the third opposing portion 11B3. Since the first flow rate is less than the second flow rate, a first cooling efficiency of the cooling air CW per unit area at the first opposing portion 11B1 is less than a second cooling efficiency of the cooling air CW per unit area at the second opposing portion 11B2. In the same manner, since the first flow rate is less than the third flow rate, the first cooling efficiency is less than a third cooling efficiency of the cooling air CW per unit area at the third opposing portion 11B3. The third cooling efficiency is greater than or equal to the second cooling efficiency. Here, the cooling efficiency refers to a cooling amount of a cooling subject per unit time. For example, when the first cooling efficiency is less than the second cooling efficiency, the cooling amount of a unit area in the first opposing portion 11B1 is less than the cooling amount of a unit area in the second opposing portion 11B2 in a unit time.

The cooling air CW that flows through the first portion 44A has a longer flow path in the passage 44 than the cooling air CW that does not flow through the first portion 44A. Further, the first cross-sectional flow area is less than the second and third cross-sectional flow areas. Accordingly, it is likely that the pressure loss becomes relatively large in the passages 44 in the first portion 44A. Thus, a first average velocity of the cooling air CW in the first portion 44A is less than a second average velocity of the cooling air CW in the second portion 44B. In the same manner, the first average velocity of the cooling air CW in the first portion 44A is less than a third average velocity of the cooling air CW in the third portion 44C. The differences in the average velocities and the cross-sectional flow areas between the first portion 44A, the second portion 44B, and the third portion 44C result in different flow rates and different cooling efficiencies. Here, the velocity refers to the distance over which the cooling air CW travels in the passage 44 per unit time in the flowing direction.

Operation of Battery Pack

The operation of the battery pack 1 will now be described with reference to FIG. 6. In FIG. 6, the ribs 43 are indicated by double-dashed lines in order to illustrate the positional relationship of the electrode body 20 and the ribs 43 of the spacer 40.

As shown in FIG. 6, the cooling air CW flowing through the first portion 44A cools the upper curved portion 32 via the first opposing portion 11B1. The cooling air CW flowing through the second portion 44B cools the flat portion 31 via the second opposing portion 11B2. The cooling air CW flowing through the third portion 44C cools the lower curved portion 33 via the third opposing portion 11B3.

The electrode body 20 is thinner in the upper curved portion 32 than the flat portion 31. Accordingly, less heat is generated in the upper curved portion 32 than the flat portion 31 during charging or discharging of the battery cell 10. Thus, the first cooling efficiency is set to be less than the second cooling efficiency such that the cooling amount in the upper curved portion 32 becomes less than the cooling amount of the flat portion 31. This avoids a situation in which the upper curved portion 32 is unnecessarily cooled.

Further, the lower curved portion 33 is thinner than the flat portion 31 in the same manner as the upper curved portion 32. Accordingly, less heat is generated in the lower curved portion 33 than the flat portion 31 during charging or discharging of the battery cell 10. However, because the liquid level of the non-aqueous electrolyte ES is below the upper curved portion 32, the upper curved portion 32 is not affected by the thermal capacity of the non-aqueous electrolyte ES. This allows the upper curved portion 32 to be cooled easily compared to the lower curved portion 33. Thus, the first cooling efficiency is set to be less than the third cooling efficiency such that the cooling amount in the upper curved portion 32 becomes less than the cooling amount of the lower curved portion 33. This avoids a situation in which the upper curved portion 32 is unnecessarily cooled.

### Advantages of the Embodiment

The advantages of the above embodiment are listed below.

(1) The electrode body 20 is accommodated in the case 11 and located toward the lower end of the case 11 so that the heat generated in the external terminals 13A and 13B when charging or discharging the battery cell 10 is less likely to be transferred to the electrode body 20. This reduces temperature variation within the electrode body 20.

(2) The first cooling efficiency is set to be less than the second cooling efficiency so as to avoid a situation in which the upper curved portion 32 is unnecessarily cooled relative to the flat portion 31. This reduces temperature variation within the electrode body 20.

(3) The first average velocity of the cooling air CW in the first portion 44A is set to be less than the second average velocity of the cooling air CW in the second portion 44B so that the first flow rate of the cooling air CW in the first portion 44A becomes less than the second flow rate of the cooling air CW in the second portion 44B. This causes the first cooling efficiency to become less than the second cooling efficiency.

(4) The first cross-sectional flow area of each passage 44 located in the first portion 44A is set to be less than the second cross-sectional flow area of each passage 44 located in the second portion 44B. This increases the pressure loss of the cooling air CW in the first portion 44A so that the first average velocity becomes less than the second average velocity. Further, the differences in the cross-sectional flow areas and the average velocities between the first portion 44A and the second portion 44B decrease the first flow rate to become less than the second flow rate effectively. This causes the first cooling efficiency to become less than the second cooling efficiency effectively.

(5) The first cooling efficiency is set to be less than the third cooling efficiency in a state in which the non-aqueous electrolyte ES contacts the lower curved surface 33S and has a liquid level below the upper curved portion 32. This avoids a situation in which the upper curved portion 32 is unnecessarily cooled, thereby reducing temperature variation within the electrode body 20.

(6) When the value of the distance D (mm) relative to the battery capacity (Ah) of the battery cell 10 is 1.57 mm/Ah or greater, further preferably, 1.96 mm/Ah or greater, the heat generated in the external terminals 13A and 13B is less likely to be transferred to the electrode body 20.

### Modified Examples

The above embodiment may be modified as described below.

When the heat generated in the external terminals 13A and 13B has no adverse effect on the electrode body 20, the value of the distance D (mm) relative to the battery capacity (Ah) of the battery cell 10 may be less than 1.57 mm/Ah. In this case, the electrode body 20 may only be accommodated in the case 11 and located toward the lower end of the case 11.

The third cooling efficiency may be less than the second cooling efficiency. For example, when the thermal capacity of the non-aqueous electrolyte ES has little effect on the cooling efficiency or when the liquid level of the non-aqueous electrolyte ES is at the upper curved portion 32 or above, it is preferred that the cooling amount of the lower curved portion 33 be less than the flat portion 31 in the same manner as the upper curved portion 32. When the third cooling efficiency is set to be less than the second cooling efficiency, the cooling amount of the lower curved portion 33 becomes less than the cooling amount of the flat portion 31. This avoids a situation in which the lower curved portion 33 is unnecessarily cooled and thereby reduces temperature variation within the electrode body 20. For example, the third cooling efficiency may be substantially equal to the first cooling efficiency.

The first cross-sectional flow area may be equal to the second cross-sectional flow area. In this case, the first average velocity of the cooling air CW in the first portion 44A may be set to less than the second average velocity of the cooling air CW in the second portion 44B such that the first cooling efficiency becomes less than the second cooling efficiency. For example, the entire length of the first portion 44A through which the cooling air CW in the passage 44 flows may be increased to be longer than the entire length of the second portion 44B through which flows the cooling air CW in the passage 44 that does not flow through the first portion 44A so that the first average velocity becomes less than the second average velocity.

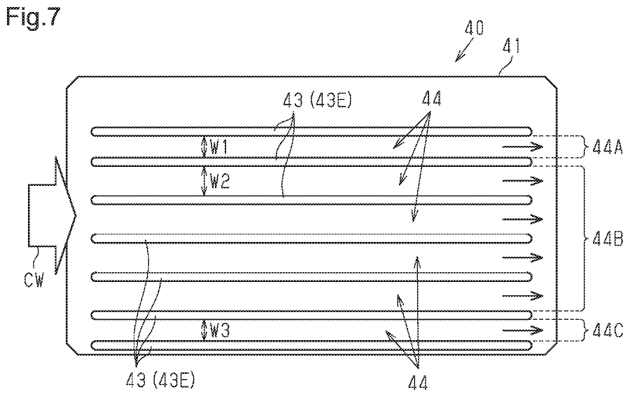

The ribs 43 do not have to be shaped as shown in FIG. 5. For example, as shown in FIG. 7, the ribs 43 may include fifth ribs 43E that are parallel to the rolling axis L1. In this case, the fifth ribs 43E form the passages 44 between the fifth ribs 43E through which the cooling air CW flows to cool the battery cell 10. A portion in the passages 44 that opposes the upper curved portion 32 with the case side wall 11B located in between defines the first portion 44A. In the first portion 44A, a single passage 44 is arranged in the vertical direction. A portion in the passages 44 that opposes the flat portion 31 with the case side wall 11B located in between defines the second portion 44B. In the second portion 44B, multiple passages 44 are arranged in the vertical direction. A portion in the passages 44 that opposes the lower curved portion 33 with the case side wall 11B located in between defines the third portion 44C. In the third portion 44C, a single passage 44 is arranged in the vertical direction. In this case, the cooling air CW flows into the passages 44 from one side end of the spacer 40 and flows out of the passages 44 from the other side of the spacer 40.

With the embodiment of the ribs 43 shown in FIG. 7, the first passage width W1 of the passage 44 located in the first portion 44A is less than the second passage width W2 of each passage 44 located in the second portion 44B. The first passage width W1 is less than the third passage width W3 of each passage 44 located in the third portion 44C. Further, the fifth ribs 43E are structured to be equal in height from one surface of the base plate 41. In an example, the passages 44 are identical in length. Since the first cross-sectional flow area is less than the second and third passage cross-sectional flow areas even in this case, the first average velocity of the cooling air CW in the first portion 44A becomes less than the second average velocity of the cooling air CW in the second portion 44B and the third average velocity of the cooling air CW in the third portion 44C. Therefore, such an embodiment also has the same advantages (1) to (6) described above.

Further, in the embodiment shown in FIG. 7, the third passage width W3 of the passage 44 located in the third portion 44C may be less than the second passage width W2 of each passage 44 located in the second portion 44B. For example, the third passage width W3 may be equal to the first passage width W1. In this case, the third cooling efficiency is less than the second cooling efficiency so that the cooling amount of the lower curved portion 33 becomes less than the cooling amount of the flat portion 31. This avoids a situation in which the lower curved portion 33 is unnecessarily cooled when the thermal capacity of the non-aqueous electrolyte ES has little effect on the cooling efficiency or when the liquid level of the non-aqueous electrolyte ES is at the upper curved portion 32 or above. Consequently, temperature variation within the electrode body 20 is reduced.

In the embodiment shown in FIG. 7, the distance between adjacent ones of the fifth ribs 43E may be identical so that each passage 44 has the same cross-sectional flow area. In this case, the velocity of the cooling air CW flowing into the passages 44 may be varied between the first portion 44A, the second portion 44B, and the third portion 44C so as to control the flow rates in the respective portions. Such an embodiment also allows the cooling efficiency to be controlled in each portion of the case side wall 11B.

As long as the first average velocity is less than the second average velocity, the velocity of the cooling air CW in the first portion 44A may be locally less than the second average velocity of the cooling air CW in the second portion 44B. Further, as long as the first cooling efficiency is less than the second cooling efficiency, the first average velocity may be greater than or equal to the second average velocity. For example, when the first cross-sectional flow area of the first portion 44A is less than the second cross-sectional flow area of the second portion 44B, the pressure of the cooling air CW flowing into the first portion 44A may be increased such that the first average velocity becomes greater than or substantially equal to the second average velocity. Even in this case, for example, as long as the first flow rate of the cooling air CW in the first portion 44A is less than the second flow rate of the cooling air CW in the second portion 44B, the first cooling efficiency becomes less than the second cooling efficiency.

The entire length of the first portion 44A through which the cooling air CW in the passage 44 flows may be shorter than or equal to the entire length of the second portion 44B through which flows the cooling air CW in the passage 44 that does not flow through the first portion 44A. Even in this case, the first cross-sectional flow area is less than the second and third passage cross-sectional flow areas. Thus, the first average velocity of the cooling air CW in the first portion 44A becomes less than the second average velocity of the cooling air CW in the second portion 44B and the third average velocity of the cooling air CW in the third portion 44C.

The battery cell 10 is not limited to a lithium-ion rechargeable battery and may be a nickel-metal hydride rechargeable battery or the like. Further, the battery cell 10 may be a rechargeable battery that uses an aqueous electrolyte instead of the non-aqueous electrolyte ES.

The battery cell 10, which is a lithium-ion rechargeable battery, may be used in an automatic transporting vehicle, a special hauling vehicle, a battery electric vehicle, a hybrid electric vehicle, a computer, an electronic device, or any other system. For example, the battery cell 10 may be used in a marine vessel, an aircraft, or any other type of movable body. The battery cell 10 may also be used in a system that supplies electric power from a power plant via a substation to buildings and households.

### Examples

Examples and comparative examples will now be described. Following examples are to illustrate the advantages of the above embodiment and not to limit the scope of the present disclosure.

Evaluation 1

In Evaluation 1, examples 1 to 3 and comparative examples 1 and 2 were used to evaluate the resulting temperature variation within the electrode body 20 when the value of the distance D (mm) relative to the battery capacity (Ah) of the battery cell 10 was varied. The value (mm/Ah) of the distance D (mm) relative to the battery capacity (Ah) of the battery cell 10 was set to 1.57 in example 1, 1.96 in example 2, 2.51 in example 3, 1.40 in comparative example 1, and 0.94 in comparative example 2. In examples 1 to 3 and comparative examples 1 and 2, the liquid level of the non-aqueous electrolyte ES was set at a height approximately the same as the upper end of the lower curved portion 33. Further, the flow rate of the cooling air CW was set such that the second flow rate was substantially equal to the third flow rate and that the first flow rate was approximately 60% of the second and third flow rates. After discharging the battery cell 10 in each of examples 1 to 3 and comparative examples 1 and 2, the temperature (° C.) was measured in the flat portion 31, the upper curved portion 32, and the lower curved portion 33 to evaluate the maximum value of temperature difference. The preferred maximum value of the difference in the temperature measured in the flat portion 31, the upper curved portion 32, and the lower curved portion 33 was less than or equal to 3.0° C. Table 1 shows the results of Evaluation 1. The difference in the temperature of the flat portion 31, the upper curved portion 32, and the lower curved portion 33 measured prior to discharging was substantially zero.

TABLE 1

| | | Temperature Difference |
|---|---|---|
| | Distance D (mm)/ | Subsequent to Discharging |
| | Battery Capacity (Ah) | (° C.) |
| Example 1 | 1.57 | 2.95 |
| Example 2 | 1.96 | 2.00 |
| Example 3 | 2.51 | 0.68 |
| Comparative | 1.40 | 3.34 |
| Example 1 | | |
| Comparative | 0.94 | 4.45 |
| Example 2 | | |

As Table 1 indicates, in examples 1 to 3, the maximum value of the temperature difference was less than or equal to 3.0° C. In particular, in example 2, the maximum value of the temperature difference was less than or equal to 2.0° C., and in example 3, the maximum value of the temperature difference was less than or equal to 1.0° C. In contrast, in comparative examples 1 and 2, the maximum value of the temperature difference was greater than 3.0° C. Therefore, it was confirmed that as the value of the distance D (mm) relative to the battery capacity (Ah) of the battery cell 10 was increased, the maximum value of the temperature difference in the electrode body 20 was decreased, in other words, the resulting temperature variation within the electrode body 20 was reduced.

Evaluation 2

In Evaluation 2, examples 4 and 5 and comparative examples 3 and 4 were used to evaluate the resulting temperature variation within the electrode body 20 when the first cooling efficiency was set to be less than the second cooling efficiency and when the first cooling efficiency was set to be equal to the second cooling efficiency. In examples 4 and 5 and comparative examples 3 and 4, the value of the distance D (mm) relative to the battery capacity (Ah) of the battery cell 10 was set to 1.57 (mm/Ah). Further, the liquid level of the non-aqueous electrolyte ES was set at a height approximately the same as the upper end of the lower curved portion 33. The first, second, and third flow rates were each set to either “flow rate 1” or “flow rate 2”. Here, “flow rate 1” equals 60% of “flow rate 2”. Then, the battery cell 10 was discharged in each of examples 4 and 5 and comparative examples 3 and 4. Subsequent to discharging, the temperature (° C.) was measured in the flat portion 31, the upper curved portion 32, and the lower curved portion 33. The preferred maximum value of difference in the temperature (° C.) measured subsequent to discharging in the flat portion 31, the upper curved portion 32, and the lower curved portion 33 was less than or equal to 3.0° C. The difference in the temperature of the flat portion 31, the upper curved portion 32, and the lower curved portion 33 measured prior to discharging was substantially zero.

In examples 4 and 5, the first and third flow rates were set to “flow rate 1”, and the second flow rate was set to “flow rate 2”. In comparative examples 3 and 4, the first, second, and third flow rates were set to “flow rate 2”. Further, in example 4 and comparative example 3, the ambient temperature was set to a room temperature (approximately 15° C. to 25° C.) during discharging. In example 5 and comparative example 4, the ambient temperature was set to a high temperature (approximately 40° C. to 50° C.) during discharging. Table 2 shows the results of Evaluation 2.

TABLE 2

| | | | | | Temperature |
|---|---|---|---|---|---|
| | | | | Temperature | Difference |
| | | | | Subsequent | Subsequent |
| | Ambient | Measurement | Flow | to Discharging | to Discharging |
| | Temperature | Position | Rate | (° C.) | (° C.) |
| Example 4 | Room | Upper Curved Portion | 1 | 38.70 | 2.90 |
| | Temperature | Flat Portion | 2 | 41.80 | |
| | | Lower Curved Portion | 1 | 38.80 | |
| Example 5 | High | Upper Curved Portion | 1 | 56.40 | 3.00 |
| | Temperature | Flat Portion | 2 | 59.30 | |
| | | Lower Curved Portion | 1 | 56.30 | |
| Comparative | Room | Upper Curved Portion | 2 | 36.90 | 4.70 |
| Example 3 | Temperature | Flat Portion | 2 | 41.60 | |
| | | Lower Curved Portion | 2 | 36.90 | |
| Comparative | High | Upper Curved Portion | 2 | 55.10 | 4.20 |
| Example 4 | Temperature | Flat Portion | 2 | 59.30 | |
| | | Lower Curved Portion | 2 | 55.10 | |

As Table 2 indicates, in examples 4 and 5, the maximum value of temperature difference between each portion subsequent to discharging was less than or equal to 3° C. In contrast, in comparative examples 3 and 4, the maximum value of temperature difference between each portion subsequent to discharging was over 3° C. (4° C. to 5° C.). Therefore, it was confirmed that the temperature variation within the electrode body 20 was reduced by decreasing the first cooling efficiency to become less than the second cooling efficiency.

The present disclosure includes the following example. Reference numerals of the components of the exemplary embodiments are given to facilitate understanding and not to limit the scope of the present disclosure. Some of the components described in the following example may be omitted or combined.

### Embodiment 1

A battery pack (1) in accordance with one or more examples of the present disclosure includes:
battery cells (10) arranged next to one another in a first direction, each of the battery cells including an electrode body (20), electrolyte (ES), a case (11) accommodating the electrode body and the electrolyte and having two case side walls (11B) opposing each other in the first direction, and an external terminal (13A, 13B) arranged on an upper part of the case; and
a spacer (40) arranged between two adjacent ones of the battery cells, where:
the electrode body is a flattened roll formed by rolling a stack of a positive electrode sheet, a negative electrode sheet, and a separator;
the electrode body includes a flat portion (31) having two opposing surfaces that are parallel to the two case side walls, an upper curved portion (32) having an upper curved surface (32S) that connects upper edges of the two surfaces, and a lower curved portion (33) having a lower curved surface (33S) that connects lower edges of the two surfaces;
the electrode body is accommodated in the case and located toward a lower end of the case;
the spacer presses one of the case side walls of one of the two adjacent ones of the battery cells toward an inner side of the case at a part where the one of the case side walls opposes a region from the upper curved portion to the lower curved portion,
the spacer includes passages (44) through which cooling air flows between the spacer and the one of the case side walls, and
a first cooling efficiency of the cooling air per unit area at a first opposing portion (11B1) of the one of the case side walls that opposes the upper curved portion is less than a second cooling efficiency of the cooling air per unit area at a second opposing portion (11B2) of the of the one of the case side walls that opposes the flat portion.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A battery pack, comprising:
battery cells, each including an electrode body, an electrolyte, a case accommodating the electrode body and the electrolyte, and an external terminal arranged on an upper part of the case, the battery cells being arranged next to one another in a single direction; and
a spacer arranged between one of two side walls of the case of one of the battery cells and one of two side walls of the case of an adjacent one of the battery cells, wherein:
the electrode body is a flattened roll formed by rolling a stack of a positive electrode sheet, a negative electrode sheet, and a separator;
the flattened roll includes a flat portion having two opposing surfaces, an upper curved portion having an upper curved surface that connects upper edges of the two surfaces, and a lower curved portion having a lower curved surface that connects lower edges of the two surfaces;
the electrode body is accommodated in the case and located toward a lower end of the case;
the spacer presses the one of the side walls toward an inner side of the corresponding case at a part where the one of the side walls opposes a region from the upper curved portion to the lower curved portion;
the spacer forms passages through which cooling air flows between the spacer and the one of the side walls; and
a first cooling efficiency of the cooling air per unit area at a first opposing portion of the one of the side walls that opposes the upper curved portion is less than a second cooling efficiency of the cooling air per unit area at a second opposing portion of the one of the side walls that opposes the flat portion.

2. The battery pack according to claim 1, wherein:
a portion in the passages that contacts the first opposing portion defines a first portion, and a portion in the passages that contacts the second opposing portion defines a second portion; and
a first average velocity of the cooling air in the first portion in a flowing direction is less than a second average velocity of the cooling air in the second portion in the flowing direction.

3. The battery pack according to claim 2, wherein a first cross-sectional flow area of each of the passages located in the first portion is less than a second cross-sectional flow area of each of the passages located in the second portion.

4. The battery pack according to claim 1, wherein:
the electrolyte contacts the lower curved surface and has a liquid level below the upper curved portion; and
the first cooling efficiency is less than a third cooling efficiency of the cooling air per unit area at a third opposing portion of the one of the side walls that opposes the lower curved portion.

5. The battery pack according to claim 1, wherein a third cooling efficiency of the cooling air per unit area at a third opposing portion of the one of the side walls that opposes the lower curved portion is less than the second cooling efficiency.

6. The battery pack according to claim 1, wherein a value of a distance from the external terminal to the electrode body relative to a battery capacity of the one of the battery cells is greater than or equal to 1.57 mm/Ah.
